(19) United States
(12) Patent Application Publication
(10) Pub. No.: US 2015/0143295 A1
(43) Pub. Date: May 21, 2015

(54) METHOD, APPARATUS, AND COMPUTER-READABLE RECORDING MEDIUM FOR DISPLAYING AND EXECUTING FUNCTIONS OF PORTABLE DEVICE

(71) Applicant: Samsung Electronics Co., Ltd., Gyeonggi-do (KR)

(72) Inventors: Hee-seok JEONG, Gyeonggi-do (KR); Dae-myung KIM, Gyeonggi-do (KR); Yong-jun LIM, Seoul (KR)

(21) Appl. No.: 14/541,831

(22) Filed: Nov. 14, 2014

(30) Foreign Application Priority Data
Nov. 15, 2013 (KR) 10-2013-0139323

(51) Int. Cl. G06F 3/0482; G06F 3/0488; G06F 3/0484

(52) U.S. Cl. CPC G06F 3/0482; G06F 3/04842; G06F 3/0488
USPC 715/825

(57) ABSTRACT

A portable device and method of selecting an executable function of the portable device are provided. The method includes receiving grip information regarding a gripping state of the portable device; determining whether the portable device is in a function list display request state according to the grip information; receiving swipe information when the portable device is determined to be in the function list display request state; displaying a function list according to the received swipe information; and executing a function selected from the displayed function list according to the received swipe information.

### PRIORITY

This application claims priority under 35 U.S.C. §119(a) to Korean Patent Application No. 10-2013-0139323, which was filed in the Korean Intellectual Property Office on Nov. 15, 2013, the content of which is incorporated herein by reference.

### BACKGROUND OF THE INVENTION

1. Field of the Invention

The present invention relates generally to a method and apparatus for displaying, selecting, and executing functions of a portable device, and more specifically, to a method and apparatus for displaying, selecting, and executing functions of a portable device based upon a gripping state of the portable device.

2. Description of the Related Art

In order to select and execute functions of a portable device, a list of executable functions may be displayed. A user may press a physical hardware key, such as a button or a switch, or may select (touch) a predetermined region or an icon on a screen, so as to display a menu or an icon list on the screen, and then select a function from the displayed menu or icon list.

The user usually grips a portable device with only one hand. Except for in particular cases, such as typing with QWERTY keys via a Software Input Panel (SIP) on a small screen, it is usually more convenient for the user to perform operations with one hand.

However, even a multi-touch device requires both hands to accurately perform the above-described operations of selecting and executing a menu. Therefore, it is inconvenient for the user to use only one hand to grip a device and also perform a series of processes, including pressing a physical key or an icon to display a list as well as searching through the list, to select a predetermined function.

Also, since each input required for each of the above-described operations is independent of that required for other operations, the user must perform many inputs of pressing or touching physical keys or icons in order to perform a desired function.

### SUMMARY OF THE INVENTION

The present invention has been made to address at least the above problems and/or disadvantages and to provide at least the advantages described below. Accordingly, an aspect of the present invention provides a method and an apparatus that allow a user to not only grip a device and initiate a function list display function, but also continuously perform three operations including displaying a function list, selecting a function, and executing the selected function, with only one hand.

According to an aspect of the present invention, a method of selecting an executable function of a portable device is provided. The method includes receiving grip information regarding a gripping state of the portable device; determining whether the portable device is in a function list display request state according to the grip information; receiving swipe information when the portable device is determined to be in the function list display request state; displaying a function list according to the received swipe information; and executing a function selected from the displayed function list according to the received swipe information.

According to another aspect of the present invention, an apparatus for selecting an executable function of a portable device is provided. The apparatus includes a grip information input unit receiving grip information regarding a gripping state of the portable device; a determination unit determining whether the portable device is in a function list display request state according to the grip information; a swipe information input unit receiving swipe information regarding a touch sensor of the portable device when the portable device is determined to be in the function list request state; a display unit displaying a function list according to the received swipe information; and an execution unit executing a function selected from the displayed function list according to the swipe information.

According to a further aspect of the present invention, a non-transitory computer-readable recording medium having recorded thereon a program, which, when executed by a computer, performs a method is provided. The method includes receiving grip information regarding a gripping state of the portable device; determining whether the portable device is in a function list display request state according to the grip information; receiving swipe information when the portable device is determined to be in the function list display request state; displaying a function list according to the received swipe information; and executing a function selected from the displayed function list according to the received swipe information.

### BRIEF DESCRIPTION OF THE DRAWINGS

The above and other aspects, features, and advantages of the present invention will be apparent from the following detailed description, when taken in conjunction with the accompanying drawings in which:

FIGS. 1A to 1F are diagrams illustrating a portable device performing a method of selecting an executable function, according to the related art;

FIG. 2 is a diagram illustrating a portable device performing a method of selecting an executable function by using grip information and swipe information, according to an embodiment of the present invention;

FIG. 3 is a block diagram of an apparatus for selecting an executable function of a portable device, according to an embodiment of the present invention;

FIG. 4 is a flowchart of a method of selecting the executable function of a portable device, according to an embodiment of the present invention;

FIG. 5 is a diagram illustrating a portable device and grip information generated by gripping the portable device, according to an embodiment of the present invention;

FIGS. 6A to 6C are diagrams illustrating examples of input swipe information regarding a touch sensor of a device, according to an embodiment of the present invention;

FIGS. 7A to 7D are diagrams illustrating examples of screens of a portable device according to a method of displaying a function list according to swipe information regarding a touch sensor of the portable device, according to an embodiment of the present invention;

FIG. 8 is a flowchart illustrating a method of selecting an executable function of a portable device, according to another embodiment of the present invention; and

FIG. 9 is a flowchart illustrating a method of selecting an executable function of a portable device, according to another embodiment of the present invention.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions may be omitted for clarity and conciseness.

Throughout the specification, it will also be understood that when an element is referred to as being “connected to” another element, it can be directly connected to the other element, or electrically connected to the other element while intervening elements may also be present.

Recently, numerous technologies related to portable devices have been developed and applied. Even when the portable devices have already been purchased, various additional functions may be provided in the portable devices by purchasing applications.

Along with a trend toward smaller portable devices, physical hardware keys have been less-commonly used, and technologies related to User Interface (UI) are being developed so that a user and a device may interact with each other via touch inputs.

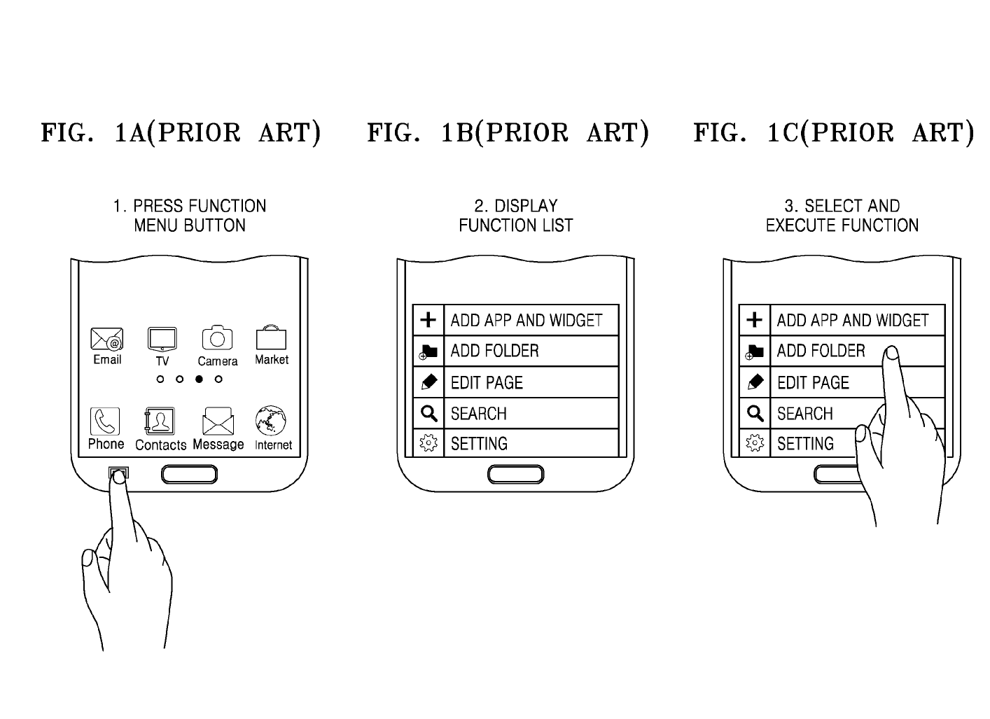

FIGS. 1A to 1F are diagrams illustrating a portable device performing a method of selecting an executable function, according to the related art.

As shown in FIGS. 1A-1F, a list of executable functions is displayed in order for a user to select and execute an executable function in the portable device. In devices of the related art using physical number keys and 4-directional navigation keys, as well as in recently developed touch devices, menus and lists may be selected and executed according to the method described below.

As illustrated in FIGS. 1A to 1C, the user may press physical hard keys such as a button or a switch to display a menu or an icon list, and then select and execute a function from the displayed menu or icon list. Alternatively, as illustrated in FIGS. 1D to 1F, the user may select (touch) a predetermined region or an icon on a screen so as to display the menu or the icon list, and then select and execute a function on the displayed menu or icon list.

The user usually grips the portable device with only one hand. Except for in particular cases, such as typing with QWERTY keys via a Software Input Panel (SIP) in a small screen, it is usually more convenient for the user to perform operations with one hand.

However, even a multi-touch device requires both hands to accurately perform the operations of selecting and executing the menu described in FIGS. 1A to 1F. Therefore, it is inconvenient for the user to use only one hand to grip a device and also perform a series of processes, including pressing a physical key or an icon to display a list as well as searching through the list, to select a predetermined function.

Also, since each input required for each of the above-described operations is independent of that required for other operations, the user must perform many inputs of pressing or touching physical keys or icons many times to perform a desired function.

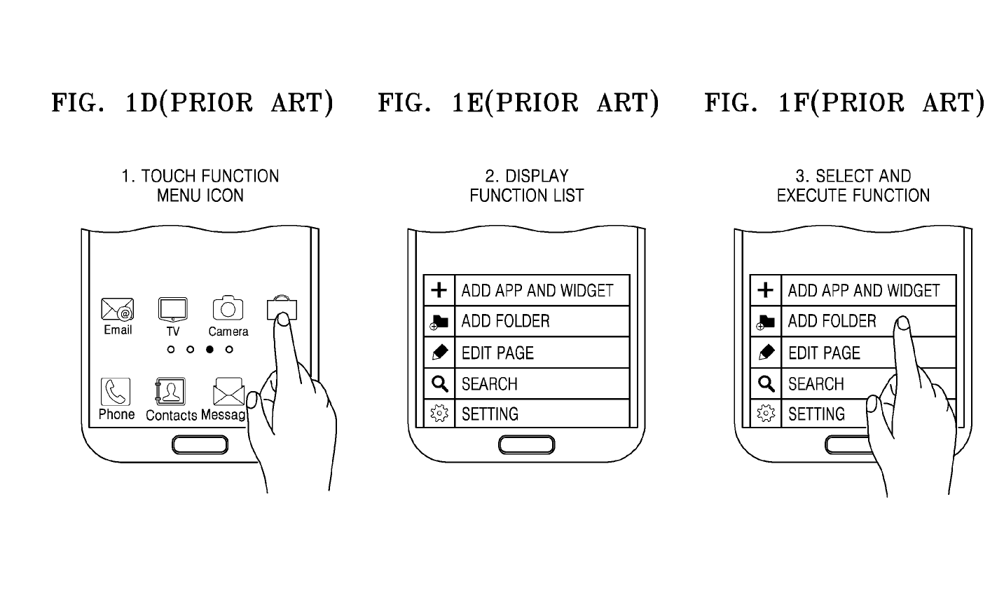

FIG. 2 is a diagram illustrating a portable device performing a method of selecting an executable function by using grip information and swipe information, according to an embodiment of the present invention.

Referring to FIG. 2, the portable device 100 includes a grip information input unit 110 and a swipe information input unit 120.

According to a method of selecting an executable function in the portable device 100 by using the grip information and the swipe information according to an embodiment of the present invention, while the user is gripping the portable device 100 with one hand, the portable device 100 receives grip information regarding a state in which the user is gripping the portable device 100 (hereinafter, referred to as “a gripping state of the portable device 100”), via the grip information input unit 110.

The portable device 100 also receives touch or swipe information generated by touching or swiping with fingers that are gripping the portable device 100, via a swipe information input unit 120.

Accordingly, the user may not only grip the portable device 100, and initiate a function list display function, but also continuously perform operations including displaying a function list, selecting a function, and executing the selected function, with only one hand.

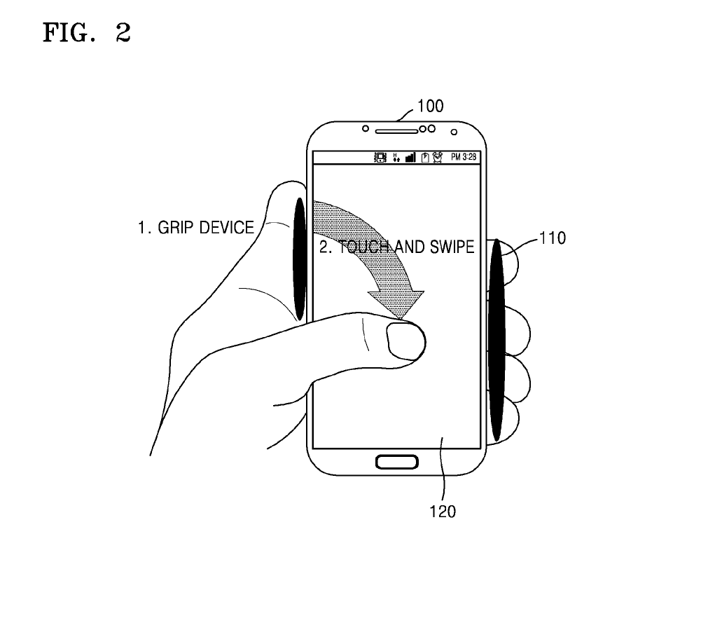

FIG. 3 is a detailed block diagram of an apparatus for selecting an executable function of a portable device, according to an embodiment of the present invention.

Referring to FIG. 3, an apparatus for selecting the executable function in the portable device 100 according to an embodiment of the present invention includes the grip information input unit 110, the swipe information input unit 120, a determination unit 130, a display unit 140, an execution unit 150, a storage unit 160, and a controller 170.

The grip information input unit 110 receives the grip information regarding the gripping state of the portable device 100. The gripping information input unit 100 may include, but is not limited to, a touch sensor, a pressure sensor, or a physical hard key.

The grip information input unit 110 may be included in any or all portions of the portable device 100. However, since the user usually grips edges and the back of the portable device 100, according to an embodiment of the present invention, the grip information input unit 110 may be provided at the edges or the back of the portable device 100.

The swipe information input unit 120 receives swipe information for initiating and displaying a list of executable functions and executing a function selected from the list in the portable device 100. The swipe information input unit 120 may include, but is not limited to, a touch sensor or a pressure sensor.

The swipe information is determined when the user touches or swipes the swipe information input unit 120 of the portable device 100. When a multi-touch sensor is used, input efficiency may be improved relative to input efficiency achievable with a one-touch input sensor, and more various types of input may be detected.

The determination unit 130 analyzes the grip information received via the grip information input unit 110, and thus determines whether the gripping state of the portable device 100 corresponds to a function list display request state.

The user may be gripping the portable device 100 when the user does not intend to display a list of executable functions but merely intends to hold the portable device 100, or when the user intends to execute and enjoy an installed application, e.g., a mobile game application.

Therefore, the apparatus for selecting the executable function in the portable device 100 according to an embodiment of the present invention is configured such that the function list is displayed only when a determination result of the determination unit 130 corresponds to the function list display request state.

When a determination result of the determination unit 130 corresponds to the function list display request state, the display unit 140 displays the function list according to the swipe information that is input via the swipe information input unit 120.

In this case, the function list may be implemented in different ways depending on whether the portable device 100 is in a hold state or an idle state, or whether an application is being executed.

For example, when the portable device 100 is idle, default functions such as “back” and “cancel,” or a device setting menu may be displayed. When an application for reproducing music is being executed, functions that are specific to the application, such as playlists, top 10 songs, favorites, or an application setting menu, may be displayed.

When the display unit 140 of the portable device 100 includes a touch or a multi-touch sensor function, the display unit 140 may function as the swipe information input unit 120. In the following examples according to embodiments of the present invention, it is assumed that the display unit 140 also functions as the swipe information input unit 120.

The execution unit 150 allows the portable device 100 to execute a function that is selected by the user from the function list displayed on the display unit 140.

In the present example, if the selected function is a default function of the portable device 100, a command for executing the selected function is transmitted to the portable device 100, and if the selected function is a function of an application, a command for executing the selected function is transmitted to the application so that the selected function is executed.

The storage unit 160 stores various information so that the apparatus for selecting the executable function of the portable device 100 determines and displays information required for selecting and executing an executable function of the portable device 100.

The apparatus for selecting the executable function of the portable device 100 may compare current grip information and previous grip information so as to determine whether the gripping state of the portable device 100 corresponds to the function list display request state. In order to perform this comparison, the apparatus may periodically store grip information that is received via the grip information input unit 110, in the storage unit 160.

The apparatus for selecting the executable function of the portable device 100 stores information regarding the function list displayed by the display unit 140 in the storage unit 160, and when a function is selected from the function list, the controller 170 transmits information regarding the function to the execution unit 150.

The controller 170 controls operations of the apparatus for selecting the executable function of the portable device 100 in general, and controls the grip information input unit 110, the swipe information input unit 120, the determination unit 130, the display unit 140, the execution unit 150, and the storage unit 160 so that the apparatus for selecting the executable function of the portable device 100 selects the executable function based on grip information and swipe information.

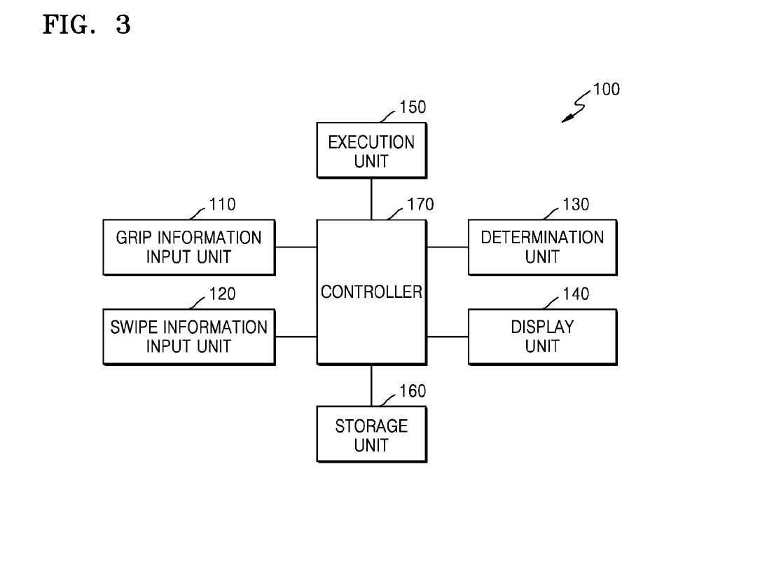

FIG. 4 is a flowchart illustrating a method of selecting the executable function of a portable device according to an embodiment of the present invention.

Referring to FIG. 4, a method of selecting the executable function of the portable device 100 starts by performing a set of processes of activating the grip information input unit 110 to prepare for reception of grip information, at step 410. The portable device 100 determines whether the grip information input unit 110 is to be activated or deactivated according to a setting of the portable device 100. The grip information input unit 110 may be activated by automatically detecting a contact with the user, or by using a function key that is assigned to activate the grip information input unit 110.

For example, the grip information input unit 110 may be attached to a side of the portable device 100 as a touch sensor or a pressure sensor. For example, if the portable device 100 is a hexahedron, the side of the portable device 100 may include four sides that share four corners at the front of the portable device 100.

Thereafter, the grip information input unit 110 receives the grip information, in step 420, and the determination unit 130 analyzes the received grip information so as to determine whether a gripping state of the portable device 100 corresponds to a function list display request state, in step 430.

The user may be gripping the portable device 100 when the user does not intend to display a list of executable functions but intends to merely hold the portable device 100, or when the user intends to execute an application installed in the portable device 100, e.g., a mobile game application, and play a game.

Therefore, the apparatus for selecting the executable function of the portable device 100 according to an embodiment of the present invention may be configured such that a function list is displayed only when a determination result of the determination unit 130 corresponds to the function list display request state.

For example, the grip information input unit 110 may be attached to the side of the portable device 100 as a touch sensor or a pressure sensor. If an exterior shape of the portable device 100 is a hexahedron (e.g., a rectangular hexahedron), the lateral sides of the portable device 100 may include four sides that share four corners at the front (e.g., a side including the display unit 140) of the portable device 100. Alternatively, the grip information input unit 110 may be attached to a plurality of sides of the portable device 100.

In this case, when the user is simply holding the portable device 100 in a particular manner without an intention to display a function list, grip information is not necessarily input via the grip information input unit 110. However, when the user intends to display a function list, the user may touch the grip information input unit 110 that is attached to a side of the portable device 100 for more than a predetermined time or a predetermined pressure level. The portable device 100 may determine the gripping state of the portable device 100 as a function list display request state when such grip information is received via the grip information input unit 110.

Alternatively, the grip information input unit 110 may be attached to the edges of the portable device 100 in the form of a touch sensor or a pressure sensor. The edges of the portable device 100 may include a bezel of the portable device 100.

Accordingly, when the user intends to display a function list, the user may touch the grip information input unit 110 that is attached to edges of the portable device 100 for more than a predetermined time or a predetermined pressure level. The portable device 100 may determine the gripping state of the portable device 100 as a function list display request state when such grip information is received via the grip information input unit 110.

According to another embodiment of the present invention, when the user touches the grip information input unit 110 at the bezel for more than a predetermined time or a predetermined pressure level, and sequentially, inputs swipe information via a touch screen (i.e., swipes continuously from the bezel to the touch screen), the gripping state of the portable device 100 may be determined as the function list display request state.

According to another embodiment of the present invention, the gripping state of the portable device 100 may be determined as the function list display request state when the user provides input via a hard key located at a certain portion of the portable device 100.

When the gripping state of the portable device 100 is determined as the function list display request state, swipe information is received via the swipe information input unit 120 (operation 440).

The swipe information input unit 120 receives swipe information for initiating and displaying a list of executable functions and executing a function selected from the list in the portable device 100. The swipe information input unit 120 may include, but is not limited to, a touch sensor or a pressure sensor.

The portable device 100 determines swipe information is determined when the user touches or swipes the swipe information input unit 120. A multi-touch sensor may be used to provide greater input efficiency relative to that provided by a one-touch input sensor, and to detect a greater variety of types of input.

When the swipe information is received via the swipe information input unit 120, the display unit 140 displays a function list according to the received swipe information, at step operation 450.

A function menu displayed according to the swipe information may be a function menu provided for a particular device or an application, or may be a menu of general functions such as list up, slide control, or combo control. However, the function menu is not limited thereto, and may be customized according to user settings in accordance with embodiments of the present invention.

All functions of a function list may be immediately shown when the swipe information is received. However, according to another embodiment of the present invention, subsets of functions of the function list may be sequentially displayed according to the received swipe information according to a swiping process of the user. For example, when the user swipes in an arc form, swipe information is input and a menu is displayed in real-time from a location where a touch input is received (touch-down) to a location where the touch input is ended (touch-up), and display of the menu may stop after the touch input has ended.

When a function is selected from the displayed function list, the selected function is executed, at step 460. A function may be selected from the function list according to an event corresponding to an end of swipe information input (i.e., a touch-up), but is not limited thereto.

If the selected function is a default function of the portable device 100, a command for executing the selected function is transmitted to the portable device 100, and if the selected function is a function of an application, a command for executing the selected function is transmitted to the application so that the selected function is executed.

After executing the selected function, the swipe information input unit 120 and the grip information input unit 110 are deactivated, and thus the method of selecting the executable function of the portable device 100 ends, at step 470.

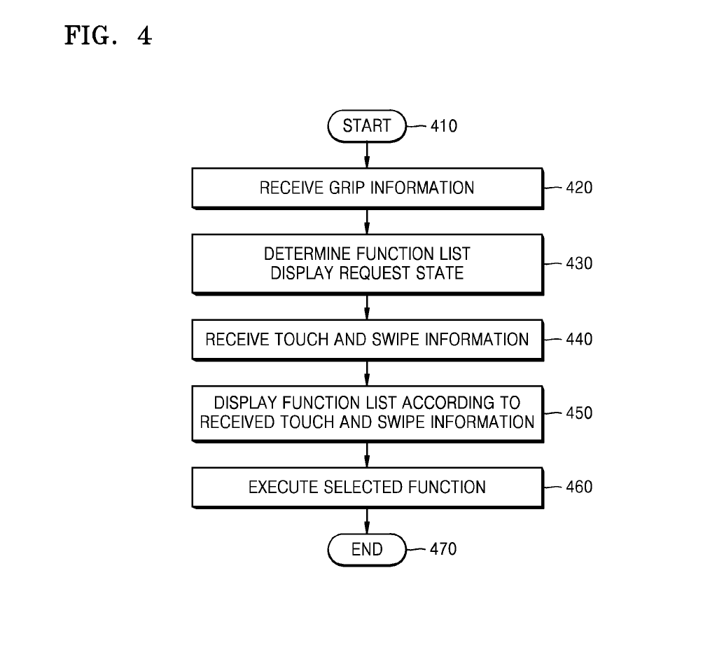

FIG. 5 is a diagram illustrating a portable device and grip information generated by gripping the portable device, according to an embodiment of the present invention.

Referring to FIG. 5, grip information regarding a gripping state of the portable device 100 is determined according to a hand shape formed when the user is gripping the portable device 100. The grip information may be realized by, for example, a touch sensor, a pressure sensor, or a physical hard key, but embodiments of the present invention are not limited thereto.

Since the user usually grips the portable device 100 such that the hand surrounds the edges and the back of the portable device 100, the grip information input unit 110 may be provided at the edges or the back of the portable device 100.

The user may be gripping the portable device 100 when the user does not intend to display a list of executable functions but intends to merely hold the portable device 100, or when the user intends to execute an application installed in the portable device 100, e.g., a mobile game application, in order to play a game.

Therefore, based on an analysis of the grip information, only when a gripping state of the portable device 100 corresponds to a function list display request state, the swipe information is received with respect to function list operations according to embodiments of the present invention, and the function list is displayed.

As described hereinabove, grip information input unit 110 may be attached to a side or the edges of the portable device 100 as a touch sensor or a pressure sensor. For example, if the portable device 100 is a hexahedron, the side of the portable device 100 may include four sides that share four corners at the front of the portable device 100. Alternatively, the grip information input unit 110 may be attached to the plurality of sides of the portable device 100.

The edges of the portable device 100 may include the bezel of the portable device 100.

When the user is simply holding the portable device 100, the user may be holding the device in a manner such that grip information is not input via the grip information input unit 110. However, when the user intends to display a function list, the user may touch the grip information input unit 110 that is attached to the side or the edges of the portable device 100 for more than a predetermined time or a predetermined pressure level. The portable device 100 may determine the gripping state of the portable device 100 as a function list display request state when such grip information is received via the grip information input unit 110, and display the function list based on the swipe information received via the swipe information input unit 120.

According to another embodiment of the present invention, when the user touches the grip information input unit 110 at the bezel for more than a predetermined time or a predetermined pressure level, and sequentially, inputs swipe information via a touch screen (i.e., swipes continuously from the bezel to the touch screen), the portable device 100 may determine the gripping state of the portable device 100 as the function list display request state, and display the function list based on the swipe information received via the swipe information input unit 120.

According to another embodiment of the present invention, when the user inputs, via a hardware key located at a certain portion of the portable device 100, the gripping state of the portable device 100 may be determined as a function list display request state, and the function list may be displayed based on the swipe information received via the swipe information input unit 120.

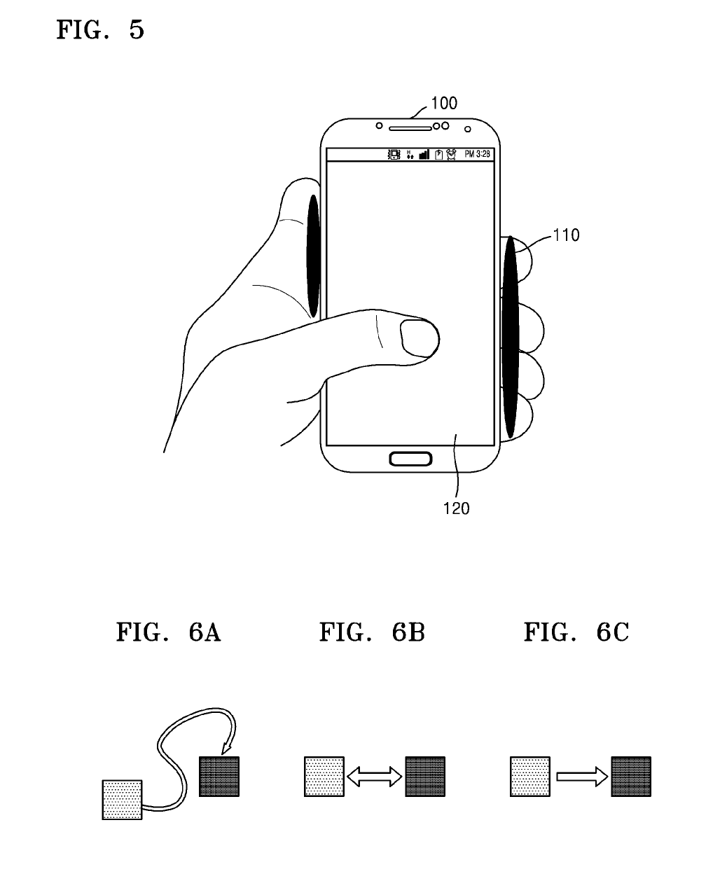

FIGS. 6A to 6C are diagrams illustrating examples of input swipe information regarding a touch sensor of a device, according to an embodiment of the present invention.

Herein, various terms, such as panning, swiping, and flicking are used with respect to input operations performed on a touch device. Due to the similarities between the operations, these terms may used interchangeably herein. From among various methods of input operations performed on the touch device, input by using fingers is described herein, but other various input operations may be used in accordance with embodiments of the present invention.

FIG. 6A is a diagram illustrating an example of panning input, in which a finger touches and then continuously drags without separating from the touch sensor, according to an embodiment of the present invention. For a panning input, there is no limitation in movement direction or the length of time of the input, and the touch sensor detects this input as panning until the finger is separated from the touch sensor.

FIG. 6B is a diagram illustrating an example of swiping input, in which the finger touches and then drags in a straight line, according to an embodiment of the present invention. For a swiping input, although there is the finger must move in a straight line, there is no limitation in the length of time of the input, and thus, the touch sensor detects as swiping until the finger is separated from the touch sensor. Swiping may also be referred to as scrolling.

FIG. 6C is a diagram illustrating an example of flicking input, which is similar to swiping, but is more limited in that the finger moves in only one direction, according to an embodiment of the present invention.

An inclusion relationship between the above-described motions may be defined such that flicking is a subset of swiping/scrolling, which, in turn, is a subset of panning That is, since panning is the most comprehensive motion, swiping or flicking may be detected as panning, and flicking may be detected as swiping. However, the motions or definitions of the terms described above may vary according to an Operation System (OS) or a platform provided in a portable device.

Recently, dragging operations performed on a touch sensor have been referred to as ‘swiping’ in general. However, in the present application, the term ‘swiping’ refers to any dragging operation performed on a touch sensor, such as panning, scrolling, and flicking.

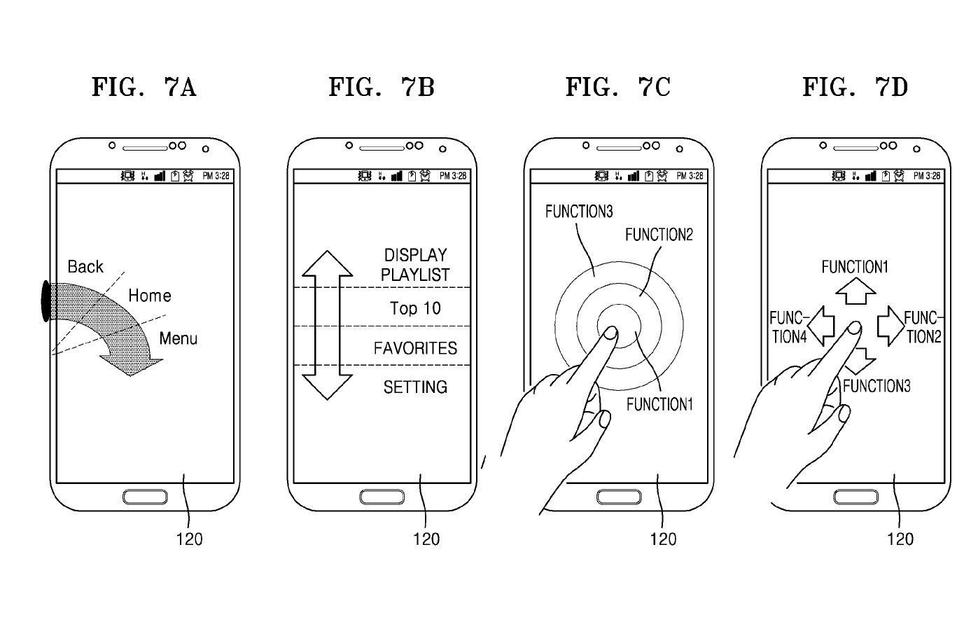

FIGS. 7A to 7D are diagrams illustrating examples of screens of a portable terminal according to a method of displaying a function list according to swipe information regarding a touch sensor of a portable device, according to an embodiment of the present invention.

Referring to FIGS. 7A to 7D, the swipe information is determined when the user touches or swipes the swipe information input unit 120 of the portable device 100. When a multi-touch sensor is used, input efficiency may be improved relative to input efficiency achievable with a one-touch input sensor, and more various types of input may be detected.

When the user is gripping the portable device 100 with a palm and four fingers excluding a thumb, the user will input the swipe information by using the thumb, and the swipe information may be displayed in an arc form according to natural movements based on a user's finger joint structure. A swipe input range may be distinguished by calculating a rotating angle from a reference point.

According to an embodiment of the present invention, the portable device 100 may determine a location where a swipe input starts (hereinafter, referred to as “touch-down”) as a 0° reference point, divide an angle formed from the reference point to a location where the swipe input ends (hereinafter, referred to as “touch-up”) into N sections according to N number of matching function menus, and match each section with a predetermined function.

FIG. 7A is a diagram illustrating an example of a screen of a portable device according to a method of displaying arc type swipe information and a function menu according to the arc type swipe information, according to an embodiment of the present invention.

Referring to FIG. 7A, the swipe information input unit 120 of the portable device 100 has received a swipe input in a function menu display request state when the swipe information may be displayed in an arc form. In the embodiment of FIG. 7A, a back function is selected and executed when a touch-up is within 0° to about 30°, a home function is selected and executed when a touch-up is within about 30° to about 60°, and a menu function is selected and executed when a touch-up is within about 60° to about 90°.

Although FIG. 7A illustrates only a range of 0° to 90°, other ranges, such as 0° to 180° or 0° to 360°, may be matched with a function menu in accordance with embodiments of the present invention. As an angle range increases, more functions may be matched with the angle range. Also, since a wide angle range is matched with each function, resolution may be improved.

According to another embodiment of the present invention, the portable device 100 may horizontally or vertically divide the swipe information input unit 120 into N sections according to N number of matching function menus, and match each section with a predetermined function.

FIG. 7B is a diagram illustrating an example of a screen of a portable device according to a method of displaying a straight vertical line type swipe information and a function menu according to the straight vertical line type swipe information, according to an embodiment of the present invention.

Referring to FIG. 7B, the swipe information input unit 120 of the portable device 100 has received a swipe input in a function menu display request state when the swipe information is displayed in a straight vertical line. In the embodiment of FIG. 7B, a playlist display function is selected and executed when a touch-up is in a first section, a top 10 display function is selected and executed when a touch-up is in a second section, a favorites display function is selected and executed when a touch-up is in a third section, and a setting menu initiate function is selected and executed when a touch-up is in a fourth section.

Although FIG. 7B illustrates an example in which only some sections of the swipe information input unit 120 are matched with a function menu, sections may be changed with respect to a size of a portable device, proportion of finger length, etc., and all sections of the swipe information input unit 120 may be matched with the function menu in accordance with embodiments of the present invention. As the sections matched with the function menu become wider, more functions may be matched to each section. When each function is matched with a wide range, resolution may be improved.

According to another embodiment of the present invention, the portable device 100 may determine a touch-down as a central point of concentric circles, divide a distance between the central point to a touch-up into N sections according to N number of matching function menus, and match each section with a predetermined function.

FIG. 7C is a diagram illustrating an example of a screen of a portable device according to a method of displaying a concentric circle form function menu having a touch input as the center, according to an embodiment of the present invention.

Referring to FIG. 7C, the swipe information input unit 120 of the portable device 100 has received a swipe input in a function menu display request state when the swipe information is displayed in concentric circles. In the embodiment of FIG. 7C, a first function “FUNCTION1” is selected and executed when a distance between the central point to a touch-up is within a first section, a second function “FUNCITON2” is selected and executed when a distance between the central point to a touch-up is within a second section, and a third function “FUNCTION3” is selected and executed when a distance between the central point to a touch-up is within a third section.

Although FIG. 7C illustrates an example in which only some sections of the swipe information input unit 120 are matched with a function menu, sections may be changed with respect to a size of a portable device, etc., and all sections of the swipe information input unit 120 may be matched with the function menu in accordance with embodiments of the present invention. As the sections matched with the function menu become wider, more functions may be matched to each section. When each function is matched with a wide range, resolution may be improved.

According to another embodiment of the present invention, the portable device 100 may determine a touch-down as a reference point, divide an angle between the reference point and a touch-up into N sections according to N number of matching function menus, and match each section with a predetermined function.

FIG. 7D is a diagram illustrating an example of a screen of a portable device according to a method of displaying a function menu according to swiping directions with respect to a touch input, according to an embodiment of the present invention.

Referring to FIG. 7D, the swipe information input unit 120 of the portable device 100 has received a swipe input in a function menu display request state when the swipe information is determined according to swiping directions. In the embodiment of FIG. 7D, a first function “FUNCITON1”, a second function “FUNCTION2”, a third function “FUNCTION3”, or a fourth function “FUNCTION4” is respectively selected and executed depending on whether a direction between a reference point and a touch-up is up, down, left, or right.

Although FIG. 7D illustrates an example in which four swiping directions, up, down, left, and right, the swiping directions are not limited thereto. As a size of the swipe information input unit 120 increases, more functions may be matched in accordance with embodiments of the present invention. Also, since each function is matched with a wide range, resolution may be improved.

Also, although not illustrated, a function menu may be displayed according to, but is not limited to, a swiping pattern on a touch sensor, a degree of pressure on the touch sensor, or a number of times of input (touch) on the touch sensor.

Also, although not illustrated, a function menu displayed based on the swipe information may be a function menu particularly provided for a device or an application, or a menu of general functions such as list up, slide control, or combo control. However, the function menu is not limited thereto, and may be customized according to user settings in accordance with embodiments of the present invention.

The swipe information may be input by using at least one selected from the above-described methods to a portable device. Alternatively, a different function menu may be displayed according to each input method so that a greater variety of function menus may be displayed.

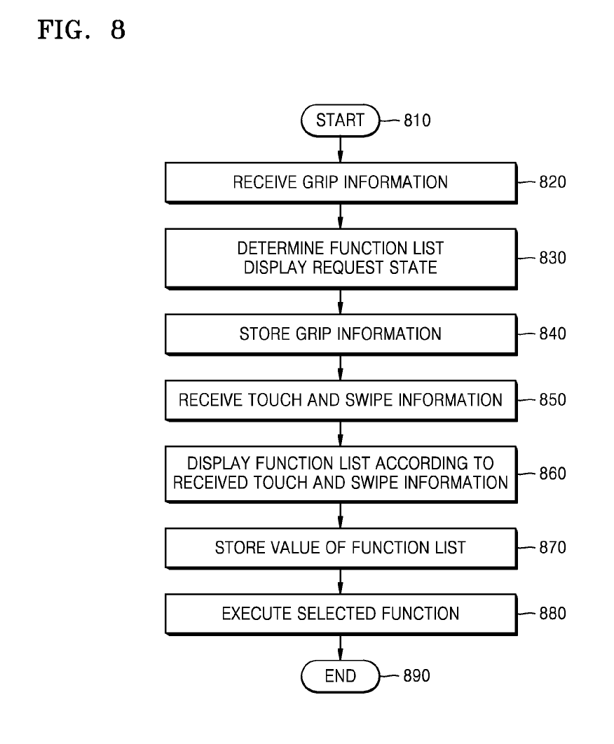

FIG. 8 is a flowchart illustrating a method of selecting an executable function of a portable device, according to another embodiment of the present invention.

The flowchart of FIG. 8 includes steps that are similar to steps included in the flowchart of FIG. 4.

Referring to FIG. 8, a method of selecting the executable function of the portable device 100 according to an embodiment of the present invention starts by performing processes of activating the grip information input unit 110 to prepare for reception of grip information, at step 810.

Thereafter, the grip information input unit 110 receives the grip information at step 820, and the determination unit 130 analyzes the received grip information to determine whether a gripping state of the portable device 100 corresponds to a function list display request state, at step 830.

Unlike the method of FIG. 4, in the method of FIG. 8, the function list display request state is determined depending on whether the grip information has changed, and the grip information is stored to determine whether the grip information has changed, at step 840.

As described above, the user may be gripping the portable device 100 when the user does not intend to display a list of executable functions of the portable device 100, but intends to merely hold the portable device 100, or when the user intends to execute an application installed in the portable device 100 (e.g., a mobile game application) and play a game. Therefore, if a gripping state (i.e., grip information) is the same as a previous state, it is determined that the gripping state does not correspond to the function list display request state.

Next, similar to the method of FIG. 4, when the gripping state of the portable device 100 is determined as a function list display request state based on a result obtained by comparing stored grip information and currently input grip information, swipe information is received via the swipe information input unit 120, at step 850.

The swipe information input unit 120 receives swipe information for initiating and displaying a list of executable functions and executing a function selected from the list in the portable device 100. The swipe information input unit 120 may include, but is not limited to, a touch sensor or a pressure sensor.

The swipe information is determined when the user touches or swipes the swipe information input unit 120 of the portable device 100. When a multi-touch sensor is used, input efficiency may be relatively improved than a one-touch input sensor, and more various types of input may be detected.

When the swipe information is received via the swipe information input unit 120, the display unit 140 may display a function list according to the received swipe information, at step 860

Unlike the method FIG. 4, when the function list is displayed according to the swipe information, values of functions in the displayed function list are stored in the storage unit 160, at step 870. Such process allows easier execution of a selected function.

Then, when a function is selected from the displayed function list, the selected function is executed, at step 880. In this example, a value of a function corresponding to a touch-up is read from the storage unit 160, and then the function is executed.

A function may be selected from the function list according to an event of an end of swipe information input (i.e., a touch-up), but a function may be selected according to other events in accordance with embodiments of the present invention.

If the selected function is a default function of the portable device 100, a command for executing the selected function is transmitted to the portable device 100, and if the selected function is a function of an application, a command for executing the selected function is transmitted to the application so that the selected function is executed.

After executing the selected function, the swipe information input unit 120 and the grip information input unit 110 are deactivated, and thus the method of selecting the executable function of the portable device 100 ends, at step 890.

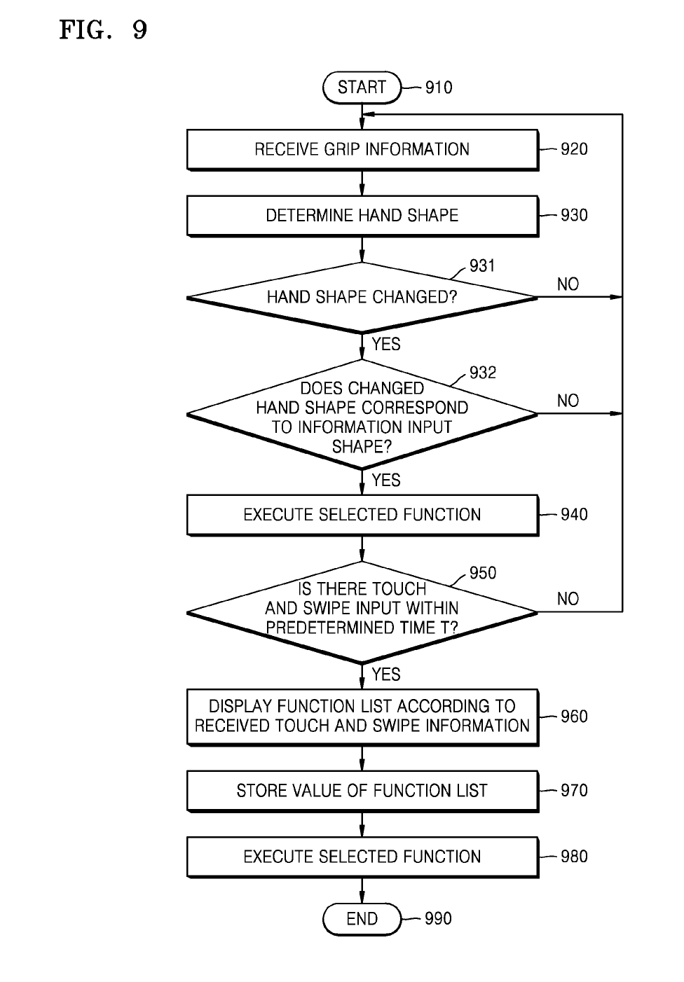

FIG. 9 is a flowchart illustrating the method of selecting the executable function of a portable device, according to another embodiment of the present invention.

Referring to FIG. 9, a method of selecting the executable function of the portable device 100 starts by performing processes of activating the grip information input unit 110 to prepare for reception of grip information, at step 910.

The apparatus for selecting the executable function of the portable device 100 periodically accumulates grip information via the grip information input unit 110, at step 920.

The grip information accumulated in step 920 is transmitted to the determination unit 130 that determines the function list display request state. The grip information is information regarding a gripping state of a device, and thus may be determined by a hand shape of a user that is gripping the device. Hereinafter, an embodiment in which hand shapes of a user that is gripping a device are compared to determine the function list display request state is described.

The determination unit 130 determines a currently received hand shape of the user, at step 930, and compares the currently received hand shape with a previous hand shape of the user, at step 931. If the comparison result shows no change in the hand shape, the portable device 100 is not in the function list display request state, and thus the method returns to the grip information input state, at step 920.

If the currently received hand shape has been changed in comparison to the previous hand shape, the determination unit 130 repeatedly determines whether the changed hand shape is in information input shape (i.e., a function list display request shape), at step 932.

If the hand shape determination result shows that the hand is simply holding the portable device 100 in a manner other than for the function list display request state, the method returns to the grip information input state, at step 920. However, if the hand shape determination result shows that the hand is in an information input shape (i.e., a function list display request shape), current hand shape information is stored in the storage unit 160, at step 940, and the portable device 100 waits to receive swipe input.

The swipe information input unit 120 periodically checks for the swipe input, and when there is no swipe input within a predetermined time ‘t’ after entering the function list display request state, the portable device 100 returns to the grip information input state, at step 920.

However, when there is a swipe input within a predetermined time t after entering the function list display request state, a function list is displayed according to received swipe information, at step 960.

If swipe input is distinguished according to its length, for example, a function list may be sequentially displayed according to a length of the swipe input received via the swipe information input unit 120, and a value of a currently displayed function list may be stored in the storage unit 160, at step 970. For example, “menu” and “home” may be respectively displayed on the display unit 140 when a length of the swipe input equals 1 cm and 2 cm, and “open menu” and “return home” may be respectively stored in the storage unit 160 as a value of a function list according to each length.

When the user performs touch-up, a value of the function list stored in the storage unit 160 is verified, and a function related to the value is performed, at step 980, and then the portable device 100 returns to the grip information input state, at step 920.

As described above, according to the one or more of the above embodiments of the present invention, a user of a portable device may use one hand to not only grip a device and initiate a function list display function, but also continuously perform three operations including displaying a function list, selecting a function, and executing the selected function, thereby addressing problems of the related art.

Certain embodiments of the present invention can also be implemented through computer-readable code/instructions in/on a medium (e.g., a computer-readable medium) to control at least one processing element to implement any above described embodiment. The medium can correspond to any medium/media permitting the storage and/or transmission of the computer-readable code.

The computer-readable code can be recorded/transferred on a medium in a variety of ways, with examples of the medium including recording media, such as magnetic storage media (e.g., Read Only Memory (ROM), floppy disks, hard disks, etc.) and optical recording media (e.g., Compact Disc (CD)-ROMs, or Digital Versatile Discs (DVDs)), and transmission media such as Internet transmission media. Thus, the medium may be such a defined and measurable structure including or carrying a signal or information, such as a device carrying a bitstream, according to one or more embodiments of the present invention. The media may also be a distributed network, so that the computer-readable code is stored/transferred and executed in a distributed fashion. Furthermore, the processing element could include a processor or a computer processor, and processing elements may be distributed and/or included in a single device.

Embodiments of the present invention described herein should be considered in a descriptive sense only and not for purposes of limitation. Descriptions of features or aspects within each embodiment should typically be considered as available for other similar features or aspects in other embodiments of the present invention.

While the present invention has been described with reference to certain embodiments thereof, it will be understood by those of ordinary skill in the art that various changes in form and details may be made therein without departing from the spirit and scope of the present invention as defined by the following claims.

What is claimed is:

1. A method of selecting an executable function of a portable device, the method comprising:
receiving grip information regarding a gripping state of the portable device;
determining whether the portable device is in a function list display request state according to the grip information;
receiving swipe information when the portable device is determined to be in the function list display request state;
displaying a function list according to the received swipe information; and
executing a function selected from the displayed function list according to the received swipe information.

2. The method of claim 1, wherein the swipe information is determined according to at least one selected from a length, a direction, an angle, a pattern, and a degree of pressure of a touch input received by swiping on a screen.

3. The method of claim 1, wherein the swipe information is determined according to at least one selected from touching-down, dragging, and touching-up of a touch input received by swiping on a screen.

4. The method of claim 1, wherein determining whether the portable device is in the function list display request state comprises determining whether the portable device is in the function list display request state according to a hand shape of a user gripping the portable device.

5. The method of claim 1, further comprising storing the grip information.

6. The method of claim 4, wherein determining whether the portable device is in the function list display request state comprises comparing the stored grip information and current grip information.

7. The method of claim 1, further comprising storing information regarding the function list that is displayed.

8. An apparatus for selecting an executable function of a portable device, the apparatus comprising:
a grip information input unit receiving grip information regarding a gripping state of the portable device;
a determination unit determining whether the portable device is in a function list display request state according to the grip information;
a swipe information input unit receiving swipe information regarding a touch sensor of the portable device when the portable device is determined to be in the function list request state;
a display unit displaying a function list according to the received swipe information; and
an execution unit executing a function selected from the displayed function list according to the swipe information.

9. The apparatus of claim 8, wherein the swipe information is determined according to at least one selected from a length, a direction, an angle, a pattern, and a degree of pressure of a touch input received by swiping on the touch sensor.

10. The apparatus of claim 8, wherein the swipe information is determined according to at least one selected from touching-down, dragging, and touching-up of a touch input received by swiping on the touch sensor.

11. The apparatus of claim 8, wherein the determination unit determines according to a hand shape of a user gripping the portable device.

12. The apparatus of claim 8, further comprising a storage unit storing the grip information.

13. The apparatus of claim 12, wherein the determination unit determines whether the portable terminal is in the function list display request state by comparing the stored grip information and current grip information.

14. The apparatus of claim 8, further comprising a storage unit storing information regarding the function list that is displayed.

15. A non-transitory computer-readable recording medium having recorded thereon a program, which, when executed by a computer, performs a method comprising:
receiving grip information regarding a gripping state of the portable device;
determining whether the portable device is in a function list display request state according to the grip information;
receiving swipe information when the portable device is determined to be in the function list display request state;
displaying a function list according to the received swipe information; and
executing a function selected from the displayed function list according to the received swipe information.

16. The non-transitory computer-readable recording medium of claim 15, wherein the swipe information is determined according to at least one selected from a length, a direction, an angle, a pattern, and a degree of pressure of a touch input received by swiping on a screen.

17. The non-transitory computer-readable recording medium of claim 15, wherein the swipe information is determined according to at least one selected from touching-down, dragging, and touching-up of a touch input received by swiping on a screen.

18. The non-transitory computer-readable recording medium of claim 15, wherein determining whether the portable device is in the function list display request state comprises determining whether the portable device is in the function list display request state according to a hand shape of a user gripping the portable device.

19. The non-transitory computer-readable recording medium of claim 15, wherein the method further comprises storing the grip information.

20. The method of claim 19, wherein determining whether the portable device is in the function list display request state comprises comparing the stored grip information and current grip information.
